(19) United States
(12) Patent Application Publication
(10) Pub. No.: US 2026/0233664 A1
(43) Pub. Date: Aug. 13, 2026

(54) NOVEL BINDING BELT TIGHTENER

(71) Applicant: Hangzhou Beast Outdoor Products Co.,Ltd., Hangzhou (CN)

(72) Inventors: Canjie ZHOU, Hangzhou (CN); Zhichao XU, Hangzhou (CN)

(21) Appl. No.: 19/204,666

(22) Filed: May 12, 2025

(30) Foreign Application Priority Data
Feb. 8, 2025 (CN) 2025101413866

(51) Int. Cl. B60P 7/08

(52) U.S. Cl. CPC B60P 7/083; B60P 7/0846

(57) ABSTRACT

The present disclosure provides a novel binding belt tightener. The tightener includes a support, a winding reel I used for winding a first section of fixing rope, a winding reel II used for winding a second section of fixing rope, a reel I clamping plate, a reel II clamping plate and a handle. A ratchet wheel I and a ratchet wheel II are coaxially arranged on the winding reel I and the winding reel II respectively, and the reel I clamping plate is movably arranged on the support in a radial direction of the winding reel I and corresponds to pawls I of the ratchet wheel I. By arranging the two winding reels, in an initial state, the fixing ropes wound around the winding reel I and the winding reel II can freely extend out for fixing the goods.

### TECHNICAL FIELD

The present disclosure relates to the technical field of binding of goods, and in particular to a novel binding belt tightener.

### BACKGROUND

During transportation of goods, it is usually necessary to bind the goods to prevent the goods from falling off or colliding. Traditional binding of the goods is usually achieved through ropes. Although this method is versatile, it takes time and effort to bind the goods, and it is difficult to bind the goods tightly.

In order to overcome the defects of the traditional binding method for the goods, a binding tightener is usually used for fixing the goods at present. Conventional binding tighteners on the market at present, such as an adjustable binding belt tightening locking mechanism with Chinese patent publication number CN117819056A, or a ratchet type binding device with pre-tightening force with publication number CN 213832237 U, have a similar principle, where a first section of rope is fixed on a carrier, a second section of rope is wound around a rotating reel provided with a ratchet wheel, after the two sections of ropes are fixed, the ratchet wheel on the rotating reel is rotated through a handle to make the movable section of the rope continuously be wound to achieve an effect of binding and tightening.

However, existing binding belt tighteners such as those described above suffer from the following defects: Firstly, since the first section of rope is fixed, when two sections of ropes are tied, a position of the tightener is at a fixed point, and the fixed section of rope is often shorter, which leads to a main body of the tightener usually located near the fixed section of rope. Such a position is also a side portion of the goods, and the tightener cannot be moved near the fixed point of the goods near the fixed section of rope, which usually causes collisions between the tightener and other goods or a carrier due to a limited scene. Secondly, when the tightener is located near the fixed section of rope, a length of the fixed section is much shorter than that of the movable section, which leads to uneven binding tightening force on two sides, which is likely to cause greater compression force on the rope on a movable side.

Based on the above-mentioned defects of the existing tighteners, this solution is put forward accordingly.

### SUMMARY

### (I) Technical Problem to be Solved

Aiming at the defects in the prior art, the present disclosure provides a novel binding belt tightener which can adjust a position of a main body of the tightener, thereby solving the problems mentioned in the background art.

### (II) Technical Solutions

To achieve the above objective, the present disclosure is implemented through the following technical solution: a novel binding belt tightener, including a support, a winding reel I used for winding a first section of fixing rope, a winding reel II used for winding a second section of fixing rope, a reel I clamping plate, a reel II clamping plate and a handle, where the winding reel I and the winding reel II are pivoted on the support, and a ratchet wheel I and a ratchet wheel II are coaxially arranged on the winding reel I and the winding reel II respectively. The reel I clamping plate is movably arranged on the support in a radial direction of the winding reel I and corresponds to pawls I of the ratchet wheel I, and the reel II clamping plate is movably arranged on the support in a radial direction of the winding reel II and corresponds to pawls II of the ratchet wheel II. The handle is rotationally arranged on the support and coaxially arranged with the winding reel I, and the handle is provided with a locking mechanism for locking the ratchet wheel I.

Preferably, the locking mechanism includes a shifting plate and a guide plate I, where a tail of the shifting plate is provided with a sliding column, the handle is provided with a sliding cavity allowing the sliding column to slide, and a spring II is arranged on the sliding column in a sleeving manner. A limiting clamping groove allowing the shifting plate to be inserted thereinto is provided between every two adjacent pawls I, and the guide plate I is arranged on the support and is positioned outside the ratchet wheel I. An outer edge of the guide plate I is sequentially provided with an initial positioning groove, an adjusting arc section and a locking positioning groove in a clockwise direction, and a side portion of the shifting plate is provided with a guide block capable of sliding in a lengthwise direction of the outer edge of the guide plate I. When the guide block is positioned in the initial positioning groove, the shifting plate is not in contact with the ratchet wheel I, and when the guide block is positioned in the adjusting arc section or the locking positioning groove, the shifting plate is capable of being clamped into the limiting clamping groove.

Preferably, the handle is further provided with a linkage mechanism, and when the guide block is positioned in the adjusting arc section or the locking positioning groove, the linkage mechanism is capable of synchronously pushing the reel II clamping plate to be clamped between the pawls II of the ratchet wheel II.

Preferably, the linkage mechanism includes a guide plate II, the guide plate II is arranged on the handle and coaxially arranged with the winding reel I, and an outer ring of the guide plate II is sequentially provided with a convex section and a concave section in a clockwise direction. When the guide block is positioned in the initial positioning groove, the concave section makes contact with the reel II clamping plate, and in this case, the reel II clamping plate does not make contact with pawls II. When the guide block is positioned in the adjusting arc section or the locking positioning groove, the convex section makes contact with the reel II clamping plate, and in this case, the reel II clamping plate is clamped between two adjacent pawls II.

Preferably, a connecting rod is arranged at a tail of the reel I clamping plate, a slide way allowing the connecting rod to slide is arranged on the support, and a spring I is arranged on the connecting rod in a sleeving manner.

Preferably, an upright post is vertically arranged on the support, a torsion spring is arranged on the upright post in a sleeving manner, a fixing hole is provided at the reel II clamping plate, and two end rods of the torsion spring abut against interiors of the support and the fixing hole respectively.

Preferably, the winding reel I and the winding reel II are hollow and are provided with openings, inner reels are coaxially arranged in the winding reel I and the winding reel II respectively, and an end portion of the fixing rope is arranged on the inner reel in a sleeving manner.

### (III) Beneficial Effects

The present disclosure provides the novel binding belt tightener. The beneficial effects are achieved as follows:
1. According to the novel binding belt tightener, by arranging the two winding reels, in an initial state, the fixing ropes wound around the winding reel I and the winding reel II can freely extend out for fixing goods, and a position of the support can be adjusted by winding and unwinding the two fixing ropes according to an actual scene, such that the support is placed at an optimal position, the situation that the support is limited by the actual scene is avoided, and the support is placed at a midpoint between the fixing ropes on two opposite sides, which can also balance pressing force of the fixing ropes on the two sides on the goods.
2. According to the novel binding belt tightener, the locking mechanism and the linkage mechanism are arranged for cooperation, tightening of the fixing rope and synchronous locking of the winding reel I and the winding reel II can be completed only by pulling the handle to a designated area, and therefore, an operation mode is simple and convenient.

### BRIEF DESCRIPTION OF THE DRAWINGS

FIG. 1 is an axonometric drawing of the present disclosure.

FIG. 2 is a reciprocal diagram of a reel I clamping plate and a ratchet wheel I of the present disclosure.

FIG. 3 is a schematic diagram of a winding reel I and an inner reel of the present disclosure.

FIG. 4 is a schematic position diagram of a guide block in an initial state of the present disclosure.

FIG. 5 is a schematic position diagram of a shifting plate and a reel II clamping plate in an initial state of the present disclosure.

FIG. 6 is a schematic position diagram of a guide block in a tightening operation state of the present disclosure.

FIG. 7 is a schematic position diagram of a shifting plate and a reel II clamping plate in a tightening operation state of the present disclosure.

FIG. 8 is a schematic position diagram of a guide block in a locked state of the present disclosure.

FIG. 9 is a schematic position diagram of a shifting plate and a reel II clamping plate in a locked state of the present disclosure.

In the figures: 1 support, 2 winding reel I, 21 inner reel, 3 winding reel II, 4 ratchet wheel I, 41 pawl I, 42 limiting clamping groove, 5 reel I clamping plate, 51 connecting rod, 52 slide way, 53 spring I, 6 reel II clamping plate, 61 upright post, 62 torsion spring, 63 fixing hole, 7 handle, 8 guide plate II, 81 convex section, 82 concave section, 9 guide plate I, 91 initial positioning groove, 92 adjusting arc section, 93 locking positioning groove, 10 shifting plate, 101 sliding column, 102 sliding cavity, 103 spring II, 11 guide block, 12 ratchet wheel II, 13 pawl II, and 14 clockwork spring case.

### DETAILED DESCRIPTIONS OF THE EMBODIMENTS

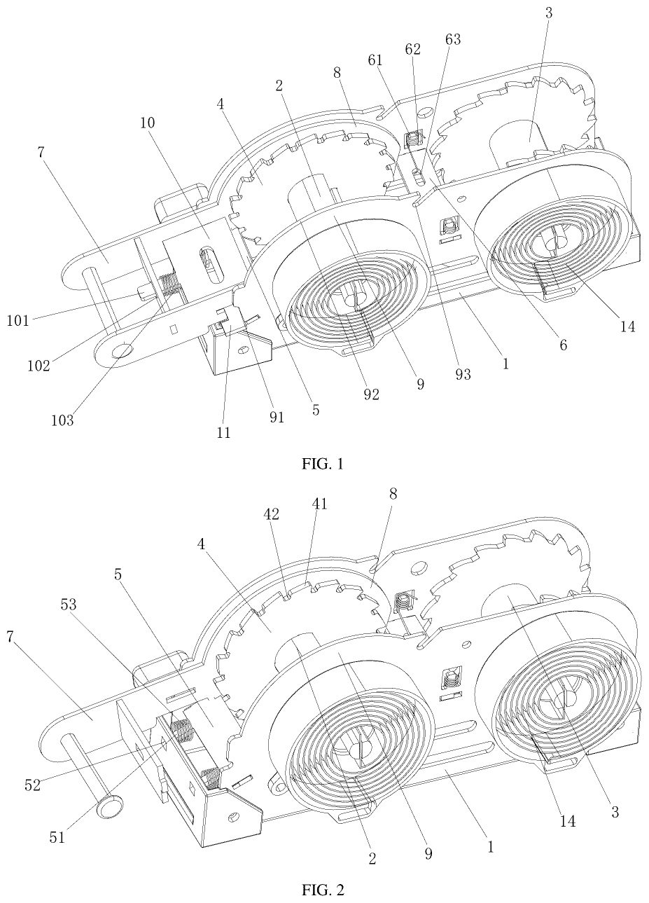

An example of the present disclosure provides a novel binding belt tightener, as shown in FIGS. 1-9, including a support 1, a winding reel I 2 used for winding a first section of fixing rope, a winding reel II 3 used for winding a second section of fixing rope, a reel I clamping plate 5, a reel II clamping plate 6 and a handle 7.

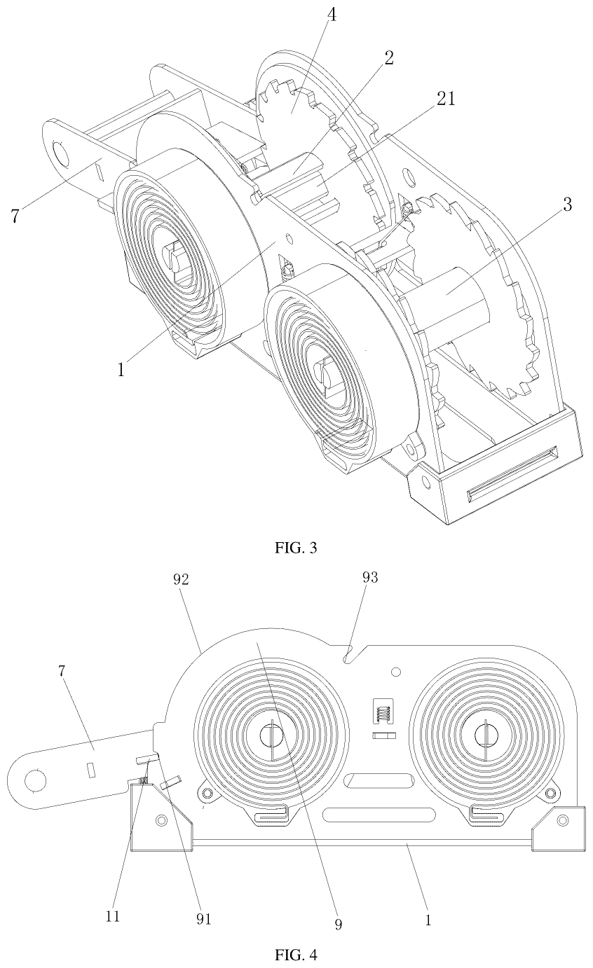

As shown in FIG. 3, the winding reel I 2 and the winding reel II 3 are pivoted on the support 1, the winding reel I 2 and the winding reel II 3 are arranged side by side, and the winding reel I 2 and the winding reel II 3 are hollow and are provided with openings. Inner reels 21 are coaxially arranged in the winding reel I 2 and the winding reel II 3 respectively, and an end portion of the fixing rope is arranged on the inner reel 21 in a sleeving manner. The fixing rope is wound around the winding reel after extending from the opening of the winding reel. The fixing rope on the winding reel I 2 is wound clockwise, and the fixing rope on the winding reel II 3 is wound counterclockwise.

As shown in FIG. 2, a ratchet wheel I 4 and a ratchet wheel II 12 are coaxially arranged on the winding reel I 2 and the winding reel II 3 respectively, where the ratchet wheel II 12 is a conventional ratchet wheel, and a ring of pawls II 13 are arranged outside the ratchet wheel II. The ratchet wheel I 2 is modified on the basis of the conventional ratchet wheel, a ring of pawls I 41 are arranged outside the ratchet wheel I, and a concave limiting clamping groove 42 is arranged at the joint between every two adjacent pawls I 41.

As shown in FIG. 1, two clockwork spring cases 14 are arranged outside the support 1, and the two clockwork spring cases 14 correspond to the winding reel I 2 and the winding reel II 3 respectively. The winding reel I 2 and the winding reel II 3 are coaxially connected to clockwork shafts at centers of the clockwork spring cases 14 respectively, a clockwork spring is wound around each clockwork shaft, an inner end of the clockwork spring is fixedly connected to the corresponding clockwork shaft, and an outer end of the clockwork spring is fixedly connected to an inner side wall of the corresponding clockwork spring case 14.

When the fixing ropes are pulled out of the winding reel I 2 and the winding reel II 3, the clockwork springs can be wound in a linked manner, and the clockwork springs are used for providing certain pre-tightening force when the fixing ropes are wound, such that winding of the fixing ropes is convenient.

As shown in FIG. 2, the reel I clamping plate 5 is movably arranged on the support 1 in a radial direction of the winding reel I 2 and corresponds to the pawls I 41 of the ratchet wheel I 4, a connecting rod 51 is arranged at a tail of the reel I clamping plate 5, a slide way 52 allowing the connecting rod 51 to slide is arranged on the support 1, and a spring I 53 is arranged on the connecting rod 51 in a sleeving manner. The spring I 53 is used for supporting the reel I clamping plate 5. Without action of external force, a distance between an end portion of the reel I clamping plate 5 and an axis of the winding reel I 2 is smaller than a diameter of an outer edge of the pawl I 41 and larger than a diameter of an inner edge of the pawl I 41. The reel I clamping plate 5 will not enter the limiting clamping groove 42.

As shown in FIG. 1, the reel II clamping plate 6 is movably arranged on the support 1 in a radial direction of the winding reel II 3 and corresponds to the pawls II 13 of the ratchet wheel II 12, the reel II clamping plate 6 is horizontally arranged, the support 1 is horizontally provided with a sliding groove, and an end portion of the reel II clamping plate 6 is provided with a sliding block slidably fitted in the sliding groove. An accommodating groove is provided at the support 1, an upright post 61 is vertically arranged in the accommodating groove, and a torsion spring 62 is arranged on the upright post 61 in a sleeving manner. A fixing hole 63 is provided at the reel II clamping plate 6, and two end rods of the torsion spring 62 abut against interiors of the support 1 and the fixing hole 63 respectively. The torsion spring 62 is used for supporting the reel II clamping plate 6. Without action of external force, the end portion of the reel II clamping plate 6 is not in contact with the pawls II 13 of the ratchet wheel II 12.

The handle 7 is rotationally arranged on the support 1 and coaxially arranged with the winding reel I 2, but the handle 7 and the winding reel I 2 are mutually independent and do not interfere with each other when rotating. The handle 7 is provided with a locking mechanism for locking the ratchet wheel I 4.

As shown in FIG. 1, the locking mechanism includes a shifting plate 10 and a guide plate I 9, where a tail of the shifting plate 10 is provided with a sliding column 101, the handle 7 is provided with a sliding cavity 102 allowing the sliding column 101 to slide, and the sliding cavity 102 is arranged in a radial direction of the winding reel I 2. A spring II 103 is arranged on the sliding column 101 in a sleeving manner, and the spring II 103 is used for providing tension force for the shifting plate 10. The shifting plate 10 can be inserted into the limiting clamping groove 42 under an action of the spring II 103. The guide plate I 9 is arranged on the support 1 and is positioned outside the ratchet wheel I 4, and an outer edge of the guide plate I 9 is sequentially provided with an initial positioning groove 91, an adjusting arc section 92 and a locking positioning groove 93 in a clockwise direction. The adjusting arc section 92 is in an arc shape, and is concentric with the winding reel I 2. The initial positioning groove 91 and the locking positioning groove 93 are recessed grooves. A side portion of the shifting plate 10 is provided with a guide block 11 capable of sliding in a lengthwise direction of the outer edge of the guide plate I 9. When the guide block 11 is positioned in the initial positioning groove 91, the shifting plate 10 is not in contact with the ratchet wheel I 4, and when the guide block 11 is positioned in the adjusting arc section 92 or the locking positioning groove 93, the shifting plate 10 is capable of being clamped into the limiting clamping groove 42.

As shown in FIG. 5, the handle 7 is further provided with a linkage mechanism, and when the guide block 11 is positioned in the adjusting arc section 92 or the locking positioning groove 93, the linkage mechanism is capable of synchronously pushing the reel II clamping plate 6 to be clamped between the pawls II 13 of the ratchet wheel II 12.

As shown in FIG. 5, the linkage mechanism includes a guide plate II 8, the guide plate II 8 is arranged on the handle 7 and coaxially arranged with the winding reel I 2, and an outer ring of the guide plate II 8 is sequentially provided with a convex section 81 and a concave section 82 in a clockwise direction. The convex section 81 is in a regular arc shape, and the convex section 81 is coaxially arranged with the winding reel I 2. The concave section 82 may be an arc or flat surface with a diameter smaller than that of the convex section 81, which is not specifically limited, and a distance from an outer edge of the concave section to an axis of the winding reel I 2 is smaller than a distance from an outer edge of the convex section 81 to the axis. When the guide block 11 is positioned in the initial positioning groove 91, the concave section 82 makes contact with the reel II clamping plate 6, and in this case, the reel II clamping plate 6 does not make contact with pawls II 13. When the guide block 11 is positioned in the adjusting arc section 92 or the locking positioning groove 93, the convex section 81 makes contact with the reel II clamping plate 6, and in this case, the reel II clamping plate 6 is clamped between two adjacent pawls II 13.

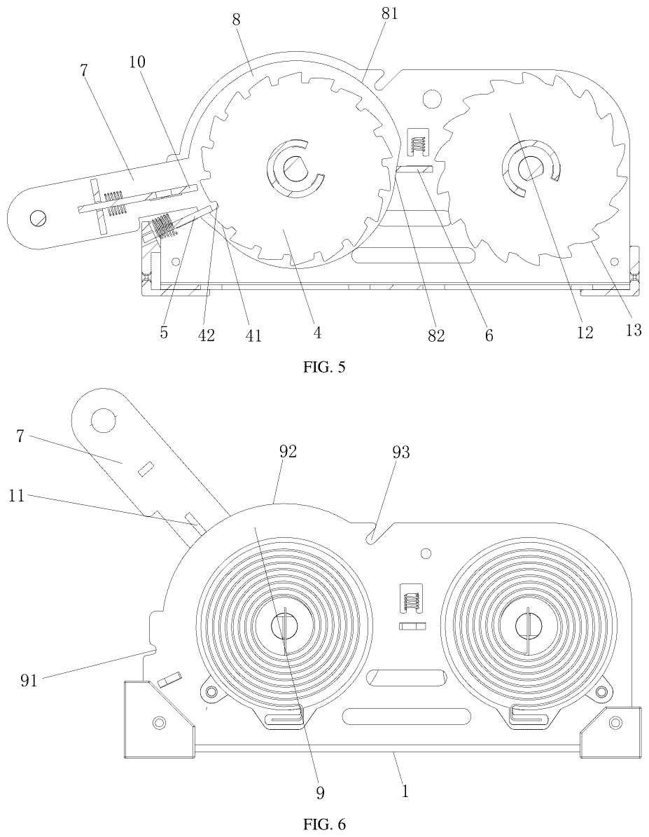

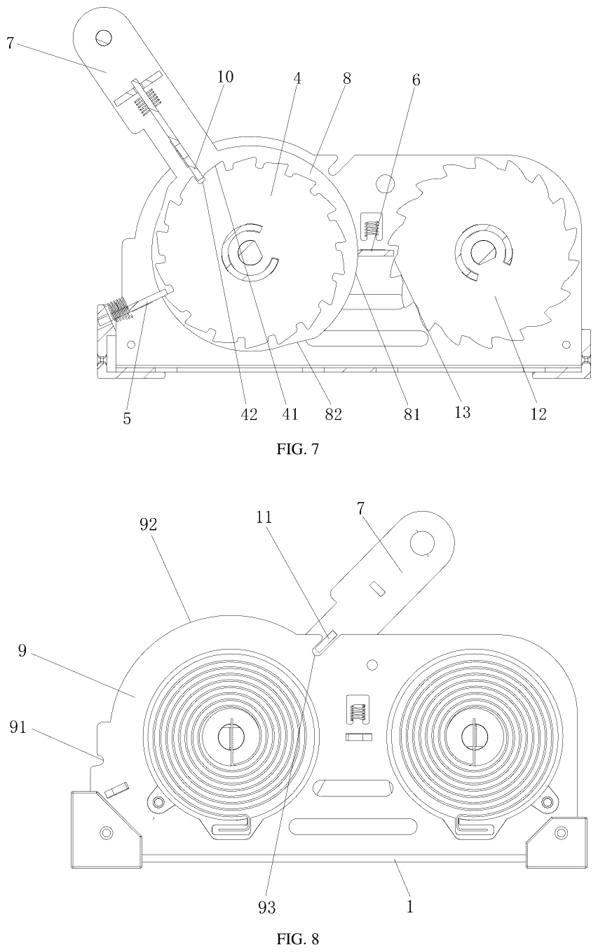

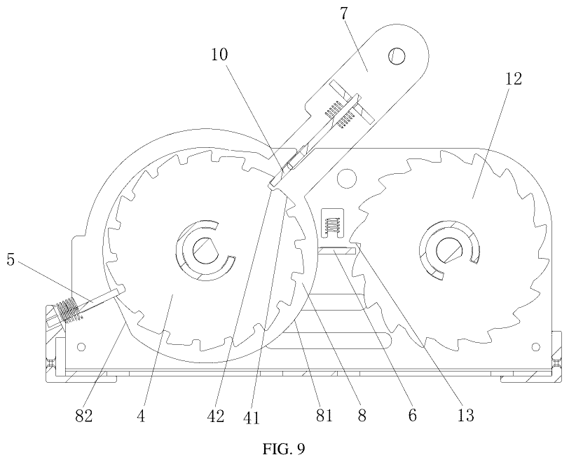

Working principle is divided into three states:
State I is an initial state. In this case, the handle 7 is made to rotate to a position shown in FIG. 4. Meanwhile, the guide block 11 is shifted into the initial positioning groove 91 under assistance of an operator. In this case, as shown in FIG. 5, the shifting plate 10 is not in contact with the ratchet wheel I 4, and the reel II clamping plate 6 is not in contact with the ratchet wheel II 12. In this state, the fixing ropes wound around the winding reel I 2 and the winding reel II 3 can freely extend out for fixing goods, and a position of the support 1 can be adjusted by winding and unwinding the two fixing ropes according to an actual scene, such that the support 1 is placed at an optimal position.
State II is a tightening operation state. When the goods are preliminarily tied up by the fixing rope, the operator pulls the guide block 11 out of the initial positioning groove 91. In this case, the handle 7 is made to rotate to a position shown in FIG. 6, and the guide block 11 enters the adjusting arc section 92. In this case, as shown in FIG. 7, the shifting plate 10 is clamped into the limiting clamping groove 42, and the reel II clamping plate 6 is clamped between two adjacent pawls II 13 under pressing of the convex section 81, such that the winding reel II 3 is limited counterclockwise. In this case, the handle 7 can circularly drive the winding reel I 2 to rotate counterclockwise multiple times in a counterclockwise direction so as to wind a surplus loose portion of the fixing rope around the winding reel I 2, thereby achieving tightening of the fixing rope for binding. The reel I clamping plate 5 provides one-way locking for the ratchet wheel I 4 during tightening operation. When the handle 7 rotates clockwise, the reel I clamping plate 5 locks clockwise rotation of the ratchet wheel I 4, such that the handle 7 can drive the winding reel I 2 to rotate counterclockwise in a reciprocating manner.
State III is a locking state. When the tightening operation of the fixing rope is completed, the handle 7 is made to rotate to a position shown in FIG. 8. In this case, the guide block 11 enters the locking positioning groove 93. As shown in FIG. 9, the shifting plate 10 is clamped into the limiting clamping groove 42 of the ratchet wheel I 4 under an action of the spring II 103 to realize complete locking of the ratchet wheel I 4. The reel II clamping plate 6 is still pressed by the convex section 81 against a deepest position between the two pawls II 13, such that the winding reel II 3 is completely locked counterclockwise.

When the fixing rope needs to be loosened, the handle 7 just needs to be reset to the position shown in FIG. 4.

Although the examples of the present disclosure have been illustrated and described, it should be understood that those of ordinary skill in the art may make various changes, modifications, replacements and variations to these examples without departing from the principle and spirit of the present disclosure, and the scope of the present disclosure is limited by the appended claims and their legal equivalents.

What is claimed is:

1. A novel binding belt tightener, comprising a support, a winding reel I used for winding a first section of fixing rope, a winding reel II used for winding a second section of fixing rope, a reel I clamping plate, a reel II clamping plate and a handle, wherein the winding reel I and the winding reel II are pivoted on the support, a ratchet wheel I and a ratchet wheel II are coaxially arranged on the winding reel I and the winding reel II respectively, the reel I clamping plate is movably arranged on the support in a radial direction of the winding reel I and corresponds to pawls I of the ratchet wheel I, the reel II clamping plate is movably arranged on the support in a radial direction of the winding reel II and corresponds to pawls II of the ratchet wheel II, the handle is rotationally arranged on the support and coaxially arranged with the winding reel I, and the handle is provided with a locking mechanism for locking the ratchet wheel I.

2. The novel binding belt tightener according to claim 1, wherein the locking mechanism comprises a shifting plate and a guide plate I, a tail of the shifting plate is provided with a sliding column, the handle is provided with a sliding cavity allowing the sliding column to slide, a spring II is arranged on the sliding column in a sleeving manner, a limiting clamping groove allowing the shifting plate to be inserted thereinto is provided between every two adjacent pawls I, the guide plate I is arranged on the support and is positioned outside the ratchet wheel I, an outer edge of the guide plate I is sequentially provided with an initial positioning groove, an adjusting arc section and a locking positioning groove in a clockwise direction, and a side portion of the shifting plate is provided with a guide block capable of sliding in a lengthwise direction of the outer edge of the guide plate I; and when the guide block is positioned in the initial positioning groove, the shifting plate is not in contact with the ratchet wheel I, and when the guide block is positioned in the adjusting arc section or the locking positioning groove, the shifting plate is capable of being clamped into the limiting clamping groove.

3. The novel binding belt tightener according to claim 2, wherein the handle is further provided with a linkage mechanism, and when the guide block is positioned in the adjusting arc section or the locking positioning groove, the linkage mechanism is capable of synchronously pushing the reel II clamping plate to be clamped between the pawls II of the ratchet wheel II.

4. The novel binding belt tightener according to claim 3, wherein the linkage mechanism comprises a guide plate II, the guide plate II is arranged on the handle and coaxially arranged with the winding reel I, and an outer ring of the guide plate II is sequentially provided with a convex section and a concave section in a clockwise direction; when the guide block is positioned in the initial positioning groove, the concave section makes contact with the reel II clamping plate, and in this case, the reel II clamping plate does not make contact with pawls II; and when the guide block is positioned in the adjusting arc section or the locking positioning groove, the convex section makes contact with the reel II clamping plate, and in this case, the reel II clamping plate is clamped between two adjacent pawls II.

5. The novel binding belt tightener according to claim 1, wherein a connecting rod is arranged at a tail of the reel I clamping plate, a slide way allowing the connecting rod to slide is arranged on the support, and a spring I is arranged on the connecting rod in a sleeving manner.

6. The novel binding belt tightener according to claim 1, wherein an upright post is vertically arranged on the support, a torsion spring is arranged on the upright post in a sleeving manner, a fixing hole is provided at the reel II clamping plate, and two end rods of the torsion spring abut against interiors of the support and the fixing hole respectively.

7. The novel binding belt tightener according to claim 1, wherein the winding reel I and the winding reel II are hollow and are provided with openings, inner reels are coaxially arranged in the winding reel I and the winding reel II respectively, and an end portion of the fixing rope is arranged on the inner reel in a sleeving manner.
